(19) United States
(12) Patent Application Publication
(10) Pub. No.: US 2011/0079247 A1
(43) Pub. Date: Apr. 7, 2011

(54) SOLUTION PREPARATION APPARATUS AND METHOD FOR TREATING INDIVIDUAL SEMICONDUCTOR WORKPIECE

(76) Inventors: Yue Ma, Shanghai (CN); Chuan He, Shanghai (CN); Guangtao Shi, Shanghai (CN); Voha Nuch, Shanghai (CN); Hui Wang, Shanghai (CN)

(21) Appl. No.: 12/736,178

(22) PCT Filed: Mar. 17, 2008
(86) PCT No.: PCT/CN2008/070514

§ 371 Date: Dec. 6, 2010

(51) Int. Cl. B08B 3/00

(52) U.S. Cl. 134/18; 134/105

(57) ABSTRACT

The invention discloses a low-cost apparatus for chemical solution preparation with controlled process parameters such as chemical age, temperature, yield of active ingredients at the point of use. In addition, this apparatus provides chamber-to-chamber consistency on these parameters across multiple processing chambers on a single wafer wet-clean system. The invention also discloses a method to use chemical solution mixture resident time to achieve optimal combined effect of temperature, reactivity and yield of active ingredients of chemical solution mixture for best wafer treatment results.

### BACKGROUND

Semiconductor devices are manufactured or fabricated on semiconductor wafers using a number of different processing steps to create transistor and interconnection elements. In forming the device elements the semiconductor wafer may undergo, for example, masking, etching, and deposition processes to form the semiconductor transistors and desired electronic circuitry to connect those transistor terminals. In particular, multiple masking, ion implantation, annealing, and plasma etching, and chemical and physical vapor deposition steps can be performed to form shallow trench, transistor well, gate, poly-silicon line, and interconnection line structures such as vias and trenches. In each step, particles and contaminations are added on front- and backside of the wafer. Those particles and contaminations can lead to defects on wafers and subsequently lowering the IC device yield. For this reason, multiple pre- and post-process cleaning, substrate preparation, and surface conditioning steps must be performed throughout microelectronic device fabrication. Among these steps, many involve the use of chemicals in liquid form, thus they are commonly termed as “wet clean”.

Traditionally, a wet clean process is done in a batch mode where a batch of wafers (normally 25 wafers) is processed in a plurality of wet chemical baths in a sequential fashion. In between two chemical baths, the processed batch of wafers is rinsed to remove any residue cleaning solution from the previous bath. In a batch mode wet process, flow velocity of the cleaning solution between the separations among wafers is relatively low as wafers stay stationary during the process; thereby the cleaning effect due to hydrodynamic flow is limited, especially in the case of cleaning smaller particles. The queue time for the batch of wafer to transfer from one bath to another is difficult to control as the resident time requirement for a batch in each cleaning bath is different, and the next batch must wait for the prior batch to complete before it can be transferred to the next bath, thus a high degree of process variation is unavoidable. Furthermore, cross contamination from one wafer to another in the same batch is inherent for a batch process as all wafers in the same batch are in contact with a common liquid. As wafer size migrates to 300 mm, and manufacture technology node advances to 65 nm and beyond, traditional wet bench approach can no longer effectively and reliably cleaning the particles and contamination from wafer.

Single wafer cleaning process has become an alternative choice. Single wafer cleaning equipment processes one wafer a time in a cleaning reactor referred as “chamber”, sequentially injecting multiple cleaning solutions onto wafer surface and applying a deionized (DI) water rinse between cleaning solutions. Single wafer processor gives the benefits to precisely control over wafer rotation speed (therefore the flow velocity of the cleaning liquid relative to the substrate), cleaning solution dispense time, and to completely eliminate cross-contamination among wafers. To improve productivity, single wafer cleaning equipment usually consists of a number of chambers. Commercially available systems can house as many as 12 chambers.

### PRIOR ART

A single wafer wet clean system usually includes a plurality of central chemical solution preparation subsystems for preparing a plurality of chemicals. A chemical solution prepared in the a central subsystem is fed into separate chambers via flow control lines branching out from the central subsystem.

One major challenge in single wafer wet clean process is that the processing apparatus needs to provide consistent processing conditions from wafer to wafer across all chambers, for that the end performance and yield of the working units on the workpiece largely depend on these processing conditions. Such process conditions include, but not limited to, the concentration, reactivity, temperature, and delivery rate of the active ingredients of the chemical solutions. As the number of the chambers on a single wafer wet clean apparatus can grow quite large, it becomes difficult to meet such a challenge. For example, sulfuric acid/hydrogen peroxide mixture (SPM) is often used as cleaning solution to strip photo resist residues post lithographic patterning process, and the temperature of the mixture rises with time when sulfuric acid and hydrogen peroxide are mixed together due to the exothermic reaction to create caro acid. As soon as caro acid, the active ingredient for resist strip, is generated, it begins to decompose in the solution mixture, and the decomposition rate is temperature dependent (temperature changes with time). At 72 C, the decomposition rate is about 0.2% per second, and at 92 C it is about 0.6% per second. Thus longer resident time of caro acid will significantly reduce its effective activity. Achieving the same processing conditions at the solution dispense points in different chambers requires careful engineering, and this is especially true when distance and the relative height of the chambers to the central chemical solution preparation subsystems are different for each chamber.

One way to achieve such a goal is to prepare the cleaning solution mixture at the point of use to ensure the freshness of the chemical solution to be delivered onto the wafer when requested. This method usually requires multiple sets of precision flow controllers and complicated flow-through mixing devices, one set per chamber per cleaning chemical solution. These precision flow controllers and complicated flow through mixing devices can result in a single wafer wet clean apparatus whose cost is unbearable to IC manufactures. As mentioned previously, the temperature of prepared solution mixtures often change with time due to the enthalpy of the reaction and mixing, desired process temperature may not be reached at dispense points because this method is nearly an instant mixing and dispensing technique, unless multiple sets of inline chemicals heaters are added ahead of the dispensing points, which further increase the cost of the system. An alternative method is to mix the chemicals at a location after they are dispensed from the nozzles and before reaching the semiconductor workpiece. By adjusting the distance of the mixing point to the surface of the semiconductor workpiece, very limited time control, which effective the traveling time of the mixture from the mixing point to the surface of the semiconductor workpiece, can be achieved. In a practical situation, this time is no more than a matter of a fraction of second.

The present invention is disclosed against the above grounds.

### SUMMARY OF THE INVENTION

The present invention discloses an apparatus and a method for chemical solution preparation and dispensing with controlled temperature and activity for single semiconductor wet clean process.

In one embodiment of the invention, the apparatus comprises at least one pre-heating member to pre-heat the chemical to a pre-set temperature, and at least one blending vessel for fresh chemical mixing and a chemical dispensing line connected to nozzle to dispense fresh mixed chemical solution to use point. The blending vessel comprises a plurality of chemical inlets, at least one level sensor, a gas exhaust valve connected to exhaust and a pressurized gas inlet to purge chemical solution out to the use point. The amount of the chemical solution mixture in the blending vessel is controlled for one wet clean process for one single semiconductor workpiece, and fresh chemical solution is prepared at a determined time t_f before a new wet clean process begins.

In one embodiment of the invention, a method for chemical solution preparation is also disclosed. In this method, chemicals are introduced into the blending vessel with flow control devices. The mixing process in the blending vessel starts at a pre-determined time t_f and the mixed chemical solution resides in the blending vessel for a time t_r controlled by the software control system. By controlling the residual time t_r, the temperature of the chemical solution mixture and the activity of the active reagent in the chemical solution mixture at use point are controlled to maintain an optimum combined cleaning effect. When t_r is reached, the mixed chemical solution is dispensed to the nozzle with a controlled flow rate in time t_d by purging the pressurized gas into the blending vessel with a pre-determined pressure. The gas purging process continues for a time t_p when the wet clean process is over to remove all residual chemical solution out of the blending vessel and dispense line, to ensure the next mixing chemical solution is completely fresh.

The invention discloses an apparatus for chemical solution preparation with a low cost by using simple flow control devices without inline heaters in the apparatus for each chemical dispensing line to the nozzle. The apparatus also provides fresh mixed chemical solution at use point with controlled temperature and optimum cleaning effect. The apparatus also provides fresh mixed chemical solution at use point with minimum variance among a group of semiconductor workpieces and across processing chambers.

### BRIEF DESCRIPTION OF FIGURES

FIG. 1 illustrates the part of the apparatus to deliver chemicals to the mixing point;

FIG. 2 illustrates the part of the apparatus to prepare and dispense the chemical solution;

FIG. 3 illustrates the temperature vs. time curves for different chemical pre-heating temperatures;

FIG. 4 illustrate the yield vs. time curve and activity vs. time curve for active reagent in the chemical solution mixture;

FIG. 5 illustrates the combined effect of yield and activity vs. time curve for the chemical solution mixture.

### DETAILED DESCRIPTION

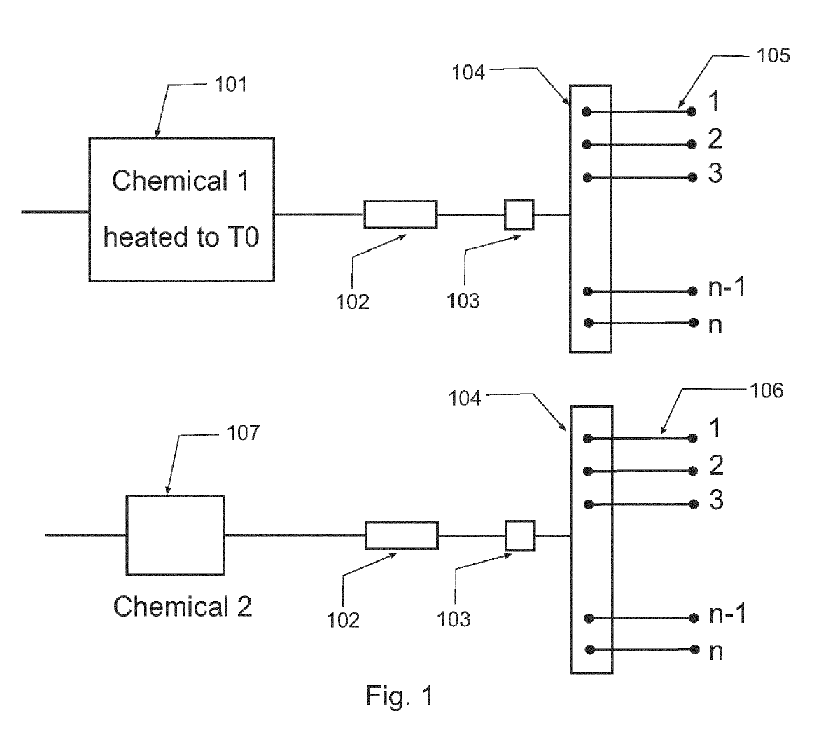

In one embodiment of the invention, as shown in FIG. 1, the apparatus comprises a bulk chemical pre-heating member 101 for heating the chemical to a pre-set temperature T0. The pre-heating member 101 is a circulation heating tank, or a in-line heater, or other liquid heating mechanisms. The material of the heating member is PVDF, PTFE, PFA or quartz. Bulk chemical is provided to the pre-heating member from the facility by the control of software control system when chemical is required for use. The pre-heating member 101 connects to a pump 102 and a flow control device 103 with a chemical dispense line. The chemical dispense line is connected to at least one chemical inlet line 105, while the control device controls the pressure in the chemical inlet line 105. The chemical inlet line 105 connects to the blending vessel with a flow control device which control the flow rate of the chemical dispensed into the blending vessel 201 with the control of pressure in the chemical inlet line 105. The chemical inlet line 105 also comprises a valve which is controlled by the software control system to start or stop dispensing chemical into the chemical blending vessel 201. Fro chemical that does not need pre-heating, the pre-heating member could be removed from the part of the apparatus for the specific chemical.

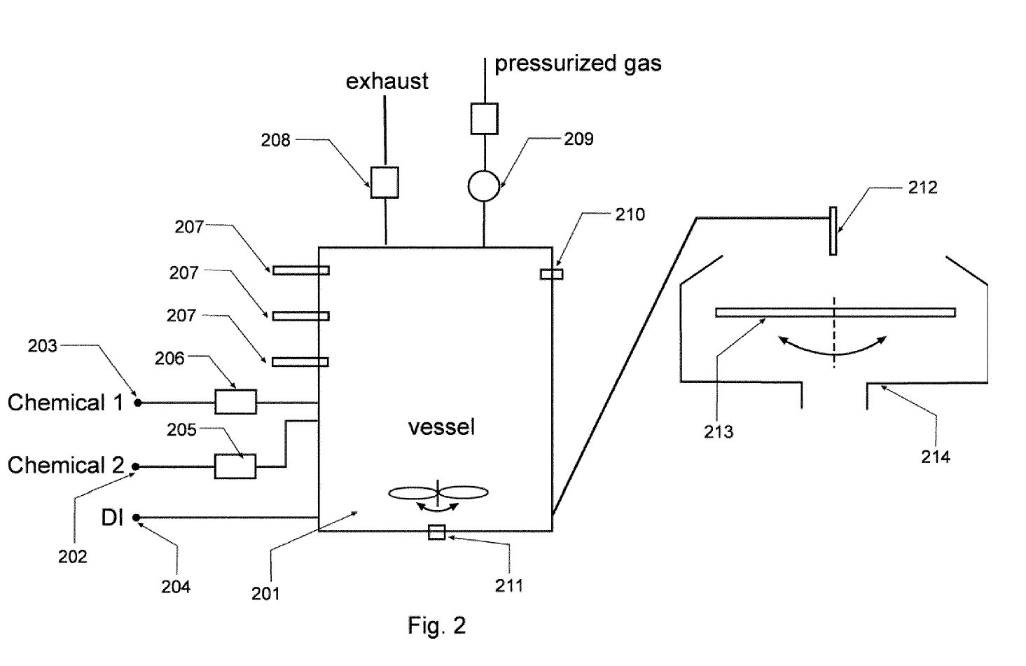

Approximate one process chamber 214 the apparatus comprises one blending vessel 201 for fresh chemical solution mixing, as shown FIG. 2. The material of the blending vessel is PFA, PVDF, PTFE or Quartz. One blending vessel 201 connects to one corresponding chemical inlet line 202 and 203 for each individual chemical. The flow rate of each chemical dispensed into the blending vessel 201 is controlled by the flow controller in each corresponding chemical inlet line, and the ratio of the flow rates of chemicals that will be mixed is pre-set. The flow control devices 205 and 206 in the chemical inlet lines are controlled by the software control system to ensure the ratio of the amount of chemicals dispensed to the blending vessel 201 to be mixed. At a pre-calculated time t before the wet clean process in the corresponding processing chamber 214 starts, the valves in the chemical inlet lines 202 and 203 are opened by the software control system to dispense corresponding chemicals into the chemical blending vessel 201 with a pre-set ratio. The blending vessel 201 comprises at least one level sensor 207 which controls the total amount of liquid chemical mixture which is determined by the process requirement. When the liquid chemical mixture level reaches the level monitored by the level sensor 207, the valves in the chemical inlet lines will close at the same time to stop dispensing chemicals into the blending vessel. The chemical solution mixture resides in the blending vessel for a time t_r after blending vessel 201 filling to reach an optimum working effect of the chemical solution mixture for the wet clean process. This optimum cleaning effect depends on the yield of the active reagent and the temperature of the solution mixture, and can be controlled by controlling the time t_r. The blending vessel 201 comprises a pressurized gas line 209 at the top of the blending vessel and a chemical dispense line near the bottom of the vessel connecting to the nozzle 202 in the processing chamber 214. When the wet process starts, pressurized gas is purged into the blending vessel 201 from the pressurized gas line 209 at the top of the blending vessel 201 with a fixed pressure to purge the fresh chemical solution mixture to the nozzle 212, then to the surface of a single semiconductor workpiece 213 in the processing chamber 214 at a fixed flow rate. The flow rate and the process time could be controlled by controlling the pressurized gas purge pressure and the total amount of chemical solution mixture in the blending vessel. When the wet process is finished, pressurized gas will continue purging for a period of time t_p to completely remove the residual chemical solution mixture out of the blending vessel 201 and the chemical dispense line from the blending vessel 201 to the nozzle 212 in the processing chamber 214. This post process purging makes no residual of chemical solution mixture in the blending vessel 201 and ensures mixing and dispensing fresh chemical solution mixture for the next wet process on a semiconductor workpiece 213. The blending vessel 201 comprises a on/off gas exhaust valve 208 at the top which is connected to the facility exhaust line. This valve 208 is closed when the pressurized gas is on and chemical solution is being dispensed to the nozzle 212. The blending vessel comprises a temperature sensor 211 and a pressure sensor 210 to monitor the temperature and pressure in the blending vessel 201.

In another embodiment of the invention, a manifold with a flow control valve is used to control the amount of chemical that is dispensed to the blending vessel 201. By controlling the pressure at the manifold and the setting of the flow control valve, the flow rate of the chemical dispensed to the blending vessel is controlled, so as to control the total amount and mixing ration of the chemical solution mixture.

In another embodiment of the invention, the mass flow controller is used to control the amount of chemical that is dispensed to the blending vessel 201. The mixing ratio could be precisely controlled by controlling the mass of the chemical dispensed to the blending vessel.

In another embodiment of the invention, the metering pump is used to control the amount of chemical that is dispensed to the blending vessel 201 from the storage tanks. The mixing ration of the two chemicals and total amount of chemical mixture can be controlled by controlling the strokes of each corresponding metering pumps in each chemical line.

In another embodiment of the invention, a method for preparing chemical solutions for a single semiconductor workpiece wet clean process is also disclosed. The method includes the following steps:

a) Generate temperature vs. time curves for a chemical mixture to be used at different initial temperatures.

b) Run a group of wafers using a full dummy sequence with desired processing times for each chemical solution mixture on the cleaning system to extract the minimum time (t_min) from when said chemical solution mixture completed dispensing to when said chemical solution mixture was dispensed again between adjacent wafers processed in the same chamber of cleaning system. Choose the smallest t_min across all chambers.

c) Determine processing parameters of the said apparatus based on desired chemical concentration, temperature at point of use (T), chemical delivery rate (q), and the amount of the chemical to be dispensed (Q), for a given cleaning process. These parameters include: temperature of heated containers for individual chemicals, T_{—}0, t_r, t_i, and t_d.

d) Set these processing parameters for said chemical solution mixture in the control software.

e) Control software validates processing parameters. Returns error and request new input if parameters are invalid.

f) Process semiconductor workpiece.

g) Said pressure release valve of said blending vessel is in open state.

h) As semiconductor workpiece is going through the process, fill process of a said blending vessel by individual chemicals begins at t=t_f−t_r−t_i.

i) As semiconductor workpiece is going through the process, fill process of a said blending vessel by individual chemicals stops at t=t_f−t_r. The volume of said chemical solution mixture in said vessel=Q.

j) As semiconductor workpiece is going through the process, said pressure release valve of said blending vessel closes at t=t_f.

k) As semiconductor workpiece is going through the process, said blending vessel is open to pressurized gas at a fixed pressure at t=t_f.

l) As semiconductor workpiece is going through the process, said chemical solution mixture in the vessel begins to dispense at t=t_f.

m) As semiconductor workpiece is going through the process, said chemical solution mixture in the vessel completes dispensing at t=t_f+t_d, and the total volume of said chemical solution mixture dispensed=Q.

n) As semiconductor workpiece is going through the process, said pressure release valve of said blending vessel opens at t=t_f+t_d+t_p.

o) As semiconductor workpiece is going through the process, said blending vessel is closed to pressurized gas at t=t_f+t_d+t_p.

p) Semiconductor wafer is ready for the next treatment step in the process.

q) Steps (f)-(p) repeat for each wafer.

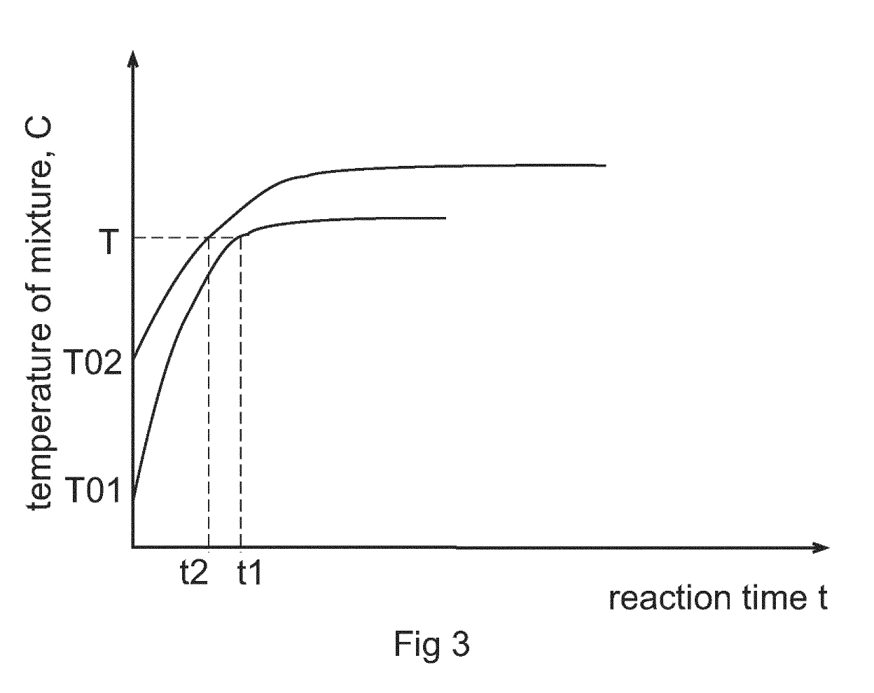

With the disclosed method, the use point temperature of the chemical solution is controlled by controlling the residual time t_r of chemical solution in the blending vessel. FIG. 3 is an established temperature vs. blending time curves with different chemical pre-heating temperatures, from which t_r is obtained with the requirement of the use point temperature. And t_r can be modified by adjusting the pre-heating temperature for chemicals.

And more specifically, controlling t_r not only controls the temperature of the chemical solution, but also controls the yield of the active reagent. The wet cleaning effect of the chemical solution depends on two things, the yield of the active reagent generated in the chemical solution which determines the concentration of the active reagent and the activity of the active reagent which relates to the temperature of the chemical solution. An optimum working effect area could be obtained by combining the yield and activity of the active reagent, which determines the range of residual t_r. More details will be introduces in the following example in the next few paragraphs.

The disclosed apparatus and method provide a solution for fresh chemical solution preparation and dispensing with low cost. The apparatus and method warrants equal temperature and activity of chemical solution at use point with optimum cleaning effect and minimize the variance among a group of semiconductor workpieces and across processing chambers, which is important for modern single semiconductor workpiece wet cleaning process.

For a specific application, preparing SPM for a single semiconductor wet clean process will be introduced as an example for the invention of the above descriptions.

The blending apparatus comprises a pre-heating member 101 for heating concentric H₂SO₄ to a pre-set temperature T0. In this case the pre-heating member 101 is a circulation heating tank. The H₂SO₄ tank comprises a circulation loop and a heater in the circulation loop. This heating circulation loop keeps the concentric H₂SO₄ in the tank at the pre-set temperature T0. The H₂SO₄ tank connects to a bulk chemical source from facility with a pump and comprises a level sensing and control mechanism. When the level of concentric H₂SO₄ in the tank is lower than a low level which is monitored by a low level sensor, the pump will start pumping the concentric chemical from the facility chemical source into the tank until the liquid in the tank reaches a fill level which is monitored by another level sensor. The H₂SO₄ tank also connects to a manifold 104 through a flow controller 103 which controls the pressure at the manifold 104. The manifold 104 connects a plurality of independent lines 105, each of which dispenses the concentric H₂SO₄ to the corresponding chemical blending vessel 201. There are a flow controller and a valve in each independent line 105. The flow controller controls the flow rate of the H₂SO₄ that is dispensed to the chemical blending vessel 201 from the H₂SO₄ tank 101, and the valve is controlled by a software control system to start or stop dispensing H₂SO₄ into the chemical blending vessel 201.

The blending apparatus comprises a H₂O₂ tank 107 for bulk H₂O₂ storage. The H₂O₂ tank 107 connects to a bulk chemical source from facility with a pump and comprises a level sensing and control mechanism. When the level of concentric H₂O₂ in the tank is lower than the low level which is controlled by a low level sensor, the pump will start pumping the concentric chemical from the facility chemical source into the tank until the liquid in the tank reaches the fill level which is controlled by another level sensor. The H₂O₂ tank also connects to a manifold 104 through a flow controller 103 which controls the pressure at the manifold 104. The manifold 104 connects a plurality of independent lines, each of which dispenses the concentric H₂O₂ to the corresponding chemical blending vessel 201. There are a flow controller and a valve in each independent line. The flow controller controls the flow rate of the H₂O₂ that is dispensed to the chemical blending vessel from the H₂O₂ tank, and the valve is controlled by a software control system to start or stop dispensing H₂O₂ into the chemical blending vessel 201.

Approximate each processing chamber 214, there is a chemical blending vessel 201 for fresh SPM mixing. One blending vessel 201 connects to a corresponding H₂SO₄ dispensing line 203 from the H₂SO₄ tank and a corresponding H₂O₂ dispensing line 202 from the H₂O₂ tank. The flow rates of concentric H₂SO₄ and H₂O₂ to the chemical vessel are controlled by the flow controllers 205 and 206 in each corresponding line, and the ratio of the two flow rates is pre-set. The valves in the H₂SO₄ line and H₂O₂ line are controlled by the software control system to open and close at the same time, which ensures the ratio of the amount of H₂SO₄ to that of H₂O₂ dispensed to the chemical vessel 201 is well controlled since the flow rates of the two chemicals are determined.

From the temperature vs time curves in FIG. 3 for H₂SO₄ and H₂O₂ mixing, the residual time t_r for mixed H₂SO₄ and H₂O₂ is obtained based on the required process temperature T, more particularly, on the cleaning effect of the SPM solution.

As it is studied and explored in science and engineering, caro acid generated by mixing H₂SO₄ and H₂O₂ is the active reagent for the wet clean process and the cleaning effect of SPM solution depends on the yield of caro acid which determines the concentration of reagent and the temperature of the SPM solution which determines the reaction constant at the use point where SPM solution is dispensed to the surface of the semiconductor workpiece 213. It is also known that caro acid decomposes when it is generated, and the decomposition rate increases with temperature. The reactions are

H₂SO₄+H₂O₂->H₂SO₅->H₂SO₄+H₂O

And the concentration of caro acid can be calculated as following

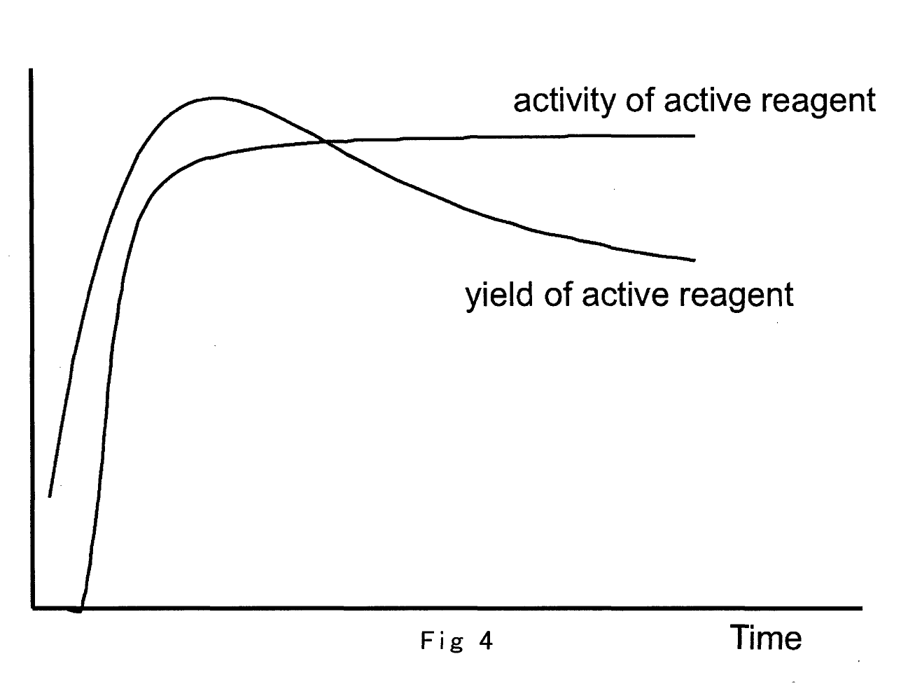

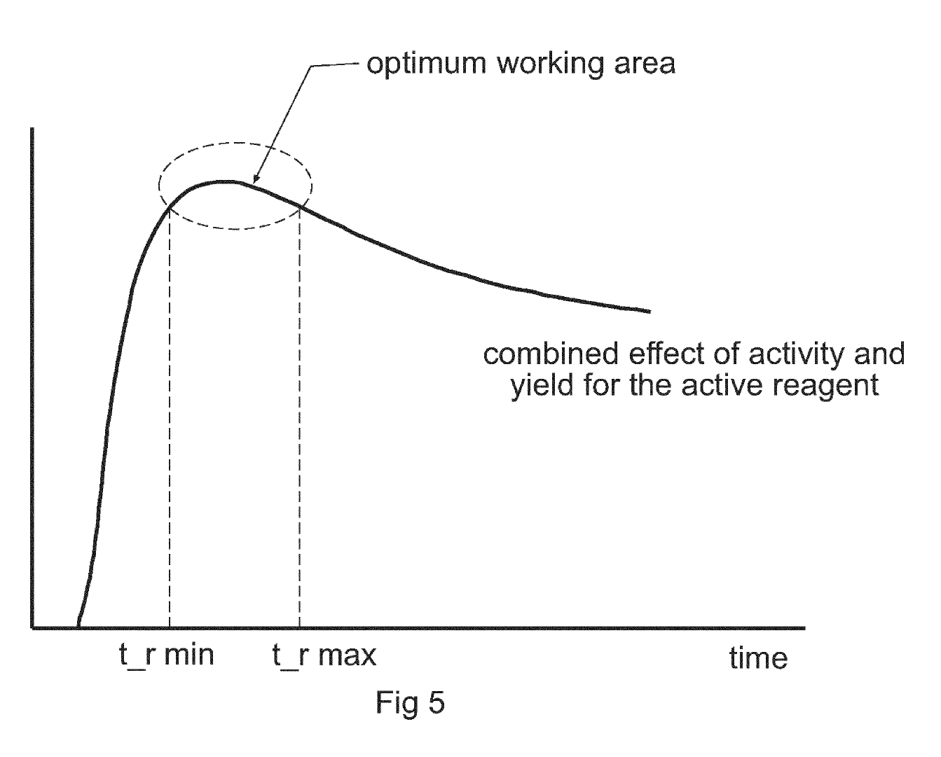

d[H₂SO₅]/dt=k₁(T(t))[H₂SO₄][H₂O₂]−k₂(T(t))[H₂SO₅]

where k₁ (T(t)) is the reaction constant for H₂SO₅ generation and k₂ (T(t)) is the reaction constant for H₂SO₅ decomposition, and both k₁(T(t)) and k₂ (T(t)) are a function of temperature T which itself is a function of blending time t. In this way, the curves of yield and reactivity of the caro acid vs. time are estimated, which is illustrated in FIG. 4. By combining these two curves, a combined effect for wet cleaning process is estimated with time which is illustrated in FIG. 5. From FIG. 5 it can be seen that the peek of the curve is the optimum working area which has a maximum cleaning effect. The optimum combined effect area determines the range of t_r which provides the chemical solution mixture having the optimum cleaning performance. The time scale for this optimum effect area is in seconds to a few minutes after mixing of H₂SO₄ and H₂O₂ depending on temperature of SPM solution. The small time scale for the optimum effect area for SPM requires freshly mixing and dispensing of chemicals and solution at use point. By exploring the temperature vs. time curve and combined effect vs. time curve for chemical mixing, the residual time t_r of SPM in the blending vessel is estimated and used to control the temperature and combined effect of fresh SPM solution dispensed to the surface of a semiconductor workpiece at use point.

By defining the filling time for dispensing both chemicals into the blending vessel and the residual time, the pre-calculated time t when the mixing of H₂SO₄ and H₂O₂ in the blending vessel starts can be obtained as

t=t_{—}r+t_{—}i

At the pre-determined time t before the SPM process in the corresponding chamber starts, the valves in the H₂SO₄ line 202 and H₂O₂ line 203 are opened by the software control system to dispense H₂SO₄ and H₂O₂ into the chemical blending vessel 201 with a pre-set ratio. The mixing of pre-heated H₂SO₄ and H₂O₂ will generate large amount of heat and increase the temperature of the liquid mixture. The H₂SO₄ and H₂O₂ will mix homogenously quickly by diffusion at high temperature and convection induced by different densities. The blending vessel 201 comprises at least one level sensor 207 which controls the total amount of SPM liquid which is determined by the process requirement. When the SPM level reaches the pre-set level, the valves in the H₂SO₄ line and H₂O₂ line will close at the same time to stop dispensing H₂SO₄ and H₂O₂ into the blending vessel, and the time for this filling process is t_i. The SPM mixture will reside in the blending vessel for a pre-set time, t_r, to reach a desired temperature and a desired active agent yield based on the temperature vs. time curves and combined effect vs. time curves. The blending vessel comprises a pressurized gas purge line 209 at the top of the blending vessel 201 and a chemical dispense line near the bottom of the vessel connecting to the nozzle 212 in the process chamber 214. When the SPM process starts, pressurized gas is purged into the blending vessel 201 from the pressurized gas line 209 at the top of the blending vessel 201 at a fixed pressure to purge the SPM liquid to the nozzle 212 in the process chamber 214 at a fixed flow rate. The flow rate and the process time t_d could be controlled by controlling the pressurized gas purge pressure and the total amount of SPM liquid in the blending vessel. When the SPM process is finished, pressurized gas will continue purging for a period of time t_p to completely remove the SPM liquid out of the blending vessel and the chemical dispense line from the blending vessel to the nozzle in the process chamber. The post process purging makes no residual of SPM in the blending vessel and ensures mixing and dispensing fresh SPM among a group of semiconductor workpieces and across processing chambers.

With the disclosed apparatus and method, fresh SPM solution is prepared and dispensed to the use point with controlled temperature and combined cleaning effect. In this way the process variance is minimized among a group of semiconductors and across processing chambers, and the optimum cleaning effect is applied, thus to save the amount of chemicals used and reduce the cost.

While the above example is directed to the preferred embodiment of the present invention, other and further applications of the invention may be devised without departing from the basic scope thereof. The scope of the invention is determined by the claims that follow.

We claim:

1. A chemical solution preparation apparatus for treating individual semiconductor workpiece comprising:
a) at least one member heating one chemical to a temperature T_{—}0;
b) a plurality of pumps and flow control device for transporting and controlling individual chemicals;
c) one blending vessel, where pre-heated chemicals are introduced, mixed and reacted into a chemical solution mixture for a controlled resident time, t_r, prior to dispensing freshly mixed chemical solution in the vessel to one semiconductor workpiece in one processing chamber; t_r controls the activity and temperature of the chemical solution mixture at point of use;
d) a software control system that sets a flag to introduce individual chemicals into said blending vessel at time t;
e) at least one chemical dispense nozzle connected to at least one chemical delivery line from said blending vessel for one processing chamber.

2. Said chemical solution preparation apparatus in claim 1 further comprises additional blending vessel for supplying chemical solution mixture to additional processing chamber.

3. Said chemical solution preparation apparatus in claim 1 wherein the said flow control device allows flow rate in a range from 0.25 to 5 liters per minute.

4. Said chemical solution preparation apparatus in claim 1 wherein the said blending vessel is made of PVDF, PFA, PTFE, PEEK polymers or quartz.

5. Said chemical solution preparation apparatus in claim 1 wherein the said blending vessel comprising:
a) vessel body;
b) on/off gas exhaust valve;
c) an inlet connected to a regulated pressurized gas source that supplies gas with a fixed pressure in the range from 0.5 to 12 psi, for driving chemical solution mixture to dispense nozzle;
d) a plurality of chemical flow inlets;
e) a plurality of liquid level sensors to control the total volume of said chemical solution mixture;
f) pressure sensor to monitor vessel pressure;
g) temperature sensor to monitor chemical solution mixture temperature.

6. Said chemical solution preparation apparatus in claim 1 wherein the volume of said blending vessel is between 0.5 to 6 liters.

7. Said chemical solution preparation apparatus in claim 1 wherein the said control software system comprising:
a) a feature to read-in user input value of t_r;
b) a look-ahead function to forecast time, t_f, when semiconductor workpiece is to be treated by said chemical solution mixture based on its current location and state of processing;
c) a feature to set t=t_f−t_r−t_i, where t_i is the time required to fill said blending vessel with a desired amount of said chemical solution mixture;
d) a feature to initiate the fill process to said blending vessels at said time, t;
e) a feature to open said on/off gas exhaust valve in claim 5 at said time, t;
f) a feature to close said on/off gas exhaust valve and connect said vessel to said pressurized gas source at time t+t_i+t_r;
g) a feature to open on/off gas exhaust valve and disconnect said vessel to said pressurized gas source at time t_f+t_d+t_p, where t_d is the time required to dispense said chemical solution mixture from said blending vessel to semiconductor workpiece, and t_p is the purge time following dispense.

8. Said chemical solution preparation apparatus in claim 1 wherein said at lease one chemical dispense nozzle is positioned above the fill lines of said chemical solution mixture relative to horizontal plane in said blending vessel.

9. A method of chemical solution preparation for treating individual semiconductor workpiece comprising:
a) generate temperature vs. time curves for a chemical solution mixture to be used at different initial temperatures;
b) run a group of wafers using a full dummy sequence with desired processing times for each chemical solution mixture on the cleaning system to extract the minimum time (t_min) from when said chemical solution mixture completed dispensing to when said chemical solution mixture was dispensed again between adjacent wafers processed in the same chamber of cleaning system; Choose the smallest t_min across all chambers;
c) determine processing parameters of the said apparatus based on desired chemical concentration, temperature at point of use (T), chemical delivery rate (q), and the amount of the chemical to be dispensed (Q), for a given cleaning process, these parameters including: T_{—}0, t_r, t_i, and t_d;
d) set these processing parameters for said chemical solution mixture in the control software;
e) control software validates processing parameters; Returns error and request new input if parameters are invalid;
f) process semiconductor workpiece;
g) said pressure release valve of said blending vessel is in open state;
h) as semiconductor workpiece is going through the process, fill process of a said blending vessel by individual chemicals begins at t=t_f−t_r−t_l;
i) as semiconductor workpiece is going through the process, fill process of a said blending vessel by individual chemicals stops at t=t_f−t_r; the volume of said chemical solution mixture in said vessel=Q;
j) as semiconductor workpiece is going through the process and is ready to receive treatment by said chemical solution mixture, said pressure release valve of said blending vessel closes, said blending vessel is open to pressurized gas at a fixed pressure, and said chemical solution mixture in the vessel begins to dispense at t=t_f;
k) as semiconductor workpiece is going through the process, said chemical solution mixture in the vessel completes dispensing at t=t_f+t_d, and the total volume of said chemical solution mixture dispensed=Q. Purge begins and lasts for t_p;
l) as semiconductor workpiece is going through the process, said pressure release valve of said blending vessel opens and said blending vessel is closed to pressurized gas at t=t_f+t_d+t_p;
m) semiconductor workpiece is ready for the next treatment step in the process;
n) steps (f)-(m) repeat for each wafer.

10. The method in claim 9 uses t_r to control the age of said chemical solution mixture.

11. The method in claim 9 uses t_r to control T of said chemical solution mixture at dispensing points; controlling T is to control reactivity of the active ingredients of said chemical solution mixture.

12. The method in claim 9 uses t_r to control the yield of active ingredients of said chemical solution mixture at dispensing points.

13. The method in claim 9 wherein varying t_r and T_{—}0 in allows different T of said chemical solution mixture at dispensing points.

14. The method in claim 9 wherein varying t_r and T_{—}0 in allows different yield of active ingredients of said chemical solution mixture at dispensing points.

15. The method in claim 9 uses t_r to optimize the combined effect of T, reactivity and yield of active ingredients of said chemical solution mixture to achieve best treatment results on semiconductor workpiece.

16. The method in claim 9 wherein the sum of t_r+t_i+t_d+t_f must less than t_min.

17. The method in claim 9 wherein t_r is in the range of 0.5 to 10 minutes.

18. The method in claim 9 wherein Q is in the range of 0.5 to 5 liters.

19. The method in claim 9 wherein fixing t_r across different processing chambers warrants equal T of said chemical solution mixture at dispense points across different processing chambers.

20. The method in claim 9 wherein fixing t_r across different processing chambers warrants equal chemical activities of said chemical solution mixture at dispense points across different processing chambers.

21. The method in claim 9 wherein fixing t_r across different processing chambers warrants minimum variation in cleaning effect among a group of semiconductor workpieces processed.

22. The method in claim 9 wherein t_r is modified by time for said chemical solution mixture temperature to reach a pre-set value, T.
